(19) United States
(12) Patent Application Publication
(10) Pub. No.: US 2001/0048089 A1
(43) Pub. Date: Dec. 6, 2001

(54) FLOW CONTROL VALVE ASSEMBLY

(76) Inventors: WILLIAM R. CLARK, HAMPSTEAD, MA (US); DAVID S. LAFLEUR, SANDOWN, NH (US)

Correspondence Address: TOBY H. KUSMER, MCDERMOTT, WILL & EMERY, 28 STATE STREET, BOSTON, MA, 02109-1775, US

(21) Appl. No.: 09/411,793

(22) Filed: Oct. 1, 1999

(51) Int. Cl. F16K 31/04; F16K 37/00

(52) U.S. Cl. 251/129.11; 137/554

(57) ABSTRACT

An improved linearized flow control valve assembly maintains a substantially consistent linear relationship between the input driving device (e.g., motor shaft) and the throughput of fluid through a valved passageway and the angle of the valve member within the passageway. Additionally, an improved linearized flow control valve assembly includes a valve position detector and signal generator which determines the position of the valve member and produces a signal representative of said position. The valve position detector and signal generator is adapted to interface with the linearizing mechanism of the valve assembly and generate the output signal as a function of a linear displacement associated with the linearizing mechanism. To compensate out trail-off or changes in linearity associated with the linearize flow control valve assembly at valve member angles associated with the open position of the valve member, a cam slot within a rack of the linearizing mechanism is curved according as a function of said non-linearity.

### FIELD OF THE INVENTION

The present invention relates generally to fluid flow control valve assemblies. More specifically, the invention relates to linearized flow control valve assemblies.

### BACKGROUND OF THE INVENTION

Fluid flow control valve assemblies are widely used in myriad applications. There are many valve assemblies in use which control the rate of fluid flow, direction of fluid flow, or both through a passageway. In non-linearized flow control valve assemblies, for example a butterfly type valve assembly, it is recognized that the flow of fluid (or throughput) through the valved passageway of the assembly has a non-linear relationship to the positioning of a valve member, which in the butterfly type valve assembly is in the form of a vane, within the passageway. Such a non-linear relationship is present in other types of non-linearized flow control valve assemblies, such as flapper valve assemblies, ball-type plug valve assemblies, etc. In these valve assemblies, the valve member typically rotates within the stream of gas flowing through the valve assembly. Typically, the valve member is mounted on a valve member shaft so that the valve member rotates about the valve member shaft axis between its fully closed to its fully opened position.

For purposes of illustration herein the angle of the valve member (or “valve member angle”) is measured relative to the closed position of the valve member. The valve member shaft axis is transverse, and typically substantially orthogonal to the flow of fluid. The throughput through the passageway of such a valve assembly is a non-linear function of the valve member angle. Thus, without further compensation, controlling the throughput purely as a function of the angle of the pivotal valve member results in a non-linear transfer function. Accordingly, steps have been taken to linearize the control of such valve assemblies, so that the relationship between the control input and the flow of fluid, or throughput, through the passageway, i.e., the transfer function, is substantially linearized, at least over a portion of the range of possible valve member angles.

As an example, a flow control valve assembly which compensates for much of the non-linearity, through a limited range of angles, is disclosed in U.S. Pat. No. 4,327,894 (“the '894 patent”), which patent is assigned to the present assignee and incorporated herein by reference. A schematic representation of the flow control valve assembly of the '894 patent is shown in FIG. 1. It is generally recognized that in such valve assemblies the cross-sectional opening of and related flow through a pivotal butterfly or similar valve assembly are a (1-cos θ) function of the valve member angle (θ₁) (the orientation of the valve member in its closed position is shown as axis X in FIG. 1). Therefore, as illustrated in FIG. 1, a compensatory cosine generator mechanism is introduced between the stepping motor 10, which controls the angular position of valve member 4, and valve shaft 4a, to linearize the relationship between the input (the position of the motor shaft 12) to the resulting flow throughput of the passageway 9 at least through a limited range of angles. In other words, equal incremental changes in the angular position of the motor shaft 12 of the motor 10 through a limited range of angles results in equal incremental changes in the flow throughput.

As a means for achieving linearized flow control, the '894 patent discloses an electrical controller 8 responding to a sensed condition (such as flow, pressure, or temperature) and delivering related control signals to electrical stepping motor 10. The shaft 12 of the motor 10 drives the valve shaft 4a through an intermediate mechanism so as to angularly position the flow-governing butterfly valve member 4 at the desired position. The movement within the intermediate mechanism in response to the motor shaft movement is transmitted to the valve shaft 4a, causing the latter and the valve member 4 to rotate about the shaft's axis. The movement of the intermediate mechanism is predesigned to cause a non-linearity offset equal and opposite to the non-linear rotating movement of the valve shaft and valve member through a limited range of rotation, so that the throughput is linearly related to the angular position of the drive motor shaft through that limited range as seen in the graph shown in FIG. 2.

In the '894 patent, the intermediate mechanism is a cosine function-generator linearizing mechanism for making the required compensating movements to provide a desired mechanical relationship between the angular position of the motor shaft 12 (the input) and the angular position of the valve member 4 (the output) so as to provide a linear transfer function. This cosine function-generator mechanism comprises a mechanical cam-and-follower unit through which the valve controlling angular movements are maintained with angular movements of the motor shaft 12. The mechanism includes a rack 6 slidable along a linear shaft. The rack includes a linear series of rack teeth that are meshed in driving relation to a pinion gear 7 in operative control of the valve shaft 4a. The rack 6 is cam-actuated to slide by amounts which are in a cos θ functional relationship with the angular excursions of the drive motor shaft 12, between and including the fully closed and open positions of the valve member 4. The motor shaft 12 turns a cam arm 14. The latter is rotatable through about a quarter of a turn (about 90°) and has a cam roller 14a at its outer end trapped within a cam slot 6a, the slot extending transversely to the rack. Rotation of the cam arm 14 causes a linear displacement of rack 6, a related actuation of the pinion gear 7, and a corresponding positioning of the valve member 4, thereby affecting the desired mechanical relationship between the motor 10 and the valve member 4.

While valve assemblies of the type shown in FIG. 1 position the valve member in response to motor position, they do not allow for accurate determination of the position of the valve member within the valve assembly if the motor fails to respond to drive signals (slips). In such linearized flow control valve assemblies it would be advantageous to know with some precision the angular position of the valve member relative to the closed position. Such feedback would enable more precise positioning of the valve member within the passageway, as well as provide additional information to those monitoring the operation of the valve assembly and the flow of fluid through the passageway. Additionally, such control would lend itself to preprogrammed position control of the valve member, for instance in a complex automated process having varied fluid flow rates through the valve assembly as a function of time or some other predetermined parameter.

The flow control valve assembly of FIG. 1 provides substantial linearity over a range of valve member angles θ₁, which as illustrated in FIG. 2 is from 0 to about 50 degrees. However, as is shown in FIG. 2, beyond about 50 degrees the ratio of the throughput of the valve assembly to the rate of change of the motor shaft angle shifts to a nonlinear function and begins to level off. Given that an angle of θ₁ equal to about 90 degrees corresponds to the valve member 4 being completely open, the degradation of the linearity results in a retarding of the response of the valve assembly in this range of angles and, consequently, the flow of fluid through the passageway. It would be advantageous to extend the linearity of the throughput with respect to the motor shaft angle over approximately the full range of angles of the valve member between the completely open and closed positions.

### SUMMARY OF THE INVENTION

In accordance with one aspect of the present invention, an improved linearized flow control valve assembly having a valve member rotatable about a rotation axis traverse to the flow of fluid through the valve, further includes an output signal generator which produces signals representative of the angular position of the valve member within a valved passageway. Additionally, the linearized flow control valve assembly may be adapted to maintain a substantially linear relationship between the throughput of fluid through the passageway and an driving input from the input source through the entire range of angles of the valve member between the fully open and closed positions.

In the preferred embodiments, the linearized flow control valve assembly includes a linearizing mechanism which translates rotational motion of an input source to a linear displacement, which in turn drives the rotation of the valve member. The linearizing mechanism is preferably cam activated, wherein a shaft from a motor of the input source rotates a cam arm rotatably affixed to a rack. The cam arm has a roller at its opposite end which moves within a cam slot formed in the rack. Rotation of the cam arm causes displacement of the roller and a corresponding linear displacement of the rack along a shaft. The rack includes a rack gear, which in one preferred embodiment includes a linear series of gear teeth which mesh with a pinion gear such that the linear displacement of the rack gear causes rotation of the pinion gear. The pinion gear is linked to the valve member and causes a corresponding rotation thereto. The result is a flow control valve assembly having a linear relationship between the throughput of the passageway and the angle of an input motor shaft, for a portion of the range of valve member angles between the fully open and closed positions.

Unlike prior art linearized flow control valve assemblies, an output signal generator provides a signal representative of the angular position of the valve member. In one embodiment the linearizing mechanism of the preferred embodiments is operationally coupled to the output signal generator such that a signal representative of the angular position of the valve member is generated as a function of the linear position of the rack.

In one embodiment the output signal generator includes a gear meshed with the linear series of rack teeth. The gear is also meshed with a rotary potentiometer or similar device. The rotary potentiometer or similar device generates a signal as a function of its displacement (and that of the rack) which is representative of the valve member angle.

In other embodiments the rotary potentiometer or similar device may be meshed directly with the pinion gear or with the rack teeth.

In yet another embodiment, an arm having a pointer is affixed to the rack, wherein the arm is oriented in the direction of the linear displacement of the rack. The pointer is oriented to be orthogonal to the orientation of the arm and is in operative communication with a linear potentiometer. Because the arm is fixed to the rack, the pointer experiences an equivalent linear displacement to that of the rack and in the same direction as the displacement of the rack. Similar to the rotary potentiometer, an output signal representative of the valve member angle is generated by the potentiometer as a function of the position of the pointer relative to the linear potentiometer, which in turn is defined by the position of the rack.

In accordance with another aspect of the invention, the linearity of the transfer function of a linearized flow control valve assembly having a valve member rotatable about an axis tranverse to the direction of flow of gas through the valve, is extended beyond the approximate fifty degree limit of the valve assembly shown in the '894 patent. In one embodiment the linearity is extended by modifying the cam slot so as to improve the linearity of the flow control valve assembly. In this embodiment a first portion of the cam slot remains straight and corresponds to valve member angles from 0 to about 50 degrees, a range where cosine linearized flow control valve assemblies of the type shown in the '894 patent are substantially linear. However, beyond about 50 degrees the linearity of prior art valve assemblies trail off, slowing the response of the valve assembly near the open position. Accordingly, beyond that range, a second portion of the cam slot is curved as a function of the trail-off to compensate for changes in linearity near the open position of the valve member. As a result, the response of the valve assembly is increased, i.e., the rate of change of position of the valve member is faster in that range of valve member angles in response to a linear rate of change of the input. The cam slot adaptation could be used in conjunction with any of the previously described valve assembly embodiments, or equivalents thereof. Furthermore, acceleration of the valve member position could be accomplished in other similar embodiments, for example, where the cam slot is left straight and the pinion gear or the rack gear is adapted in shape as a function of the trail-off beyond about 50 degrees.

### BRIEF DESCRIPTION OF THE DRAWINGS

The foregoing and other objects of this invention, the various features thereof, as well as the invention itself, may be more fully understood from the following description, when read together with the accompanying drawings, wherein:

FIG. 1 is plan view of a prior art linearized flow control valve assembly;

FIG. 2 is a graphical representation of the relationship between angular positions of the drive motor and the ratios of valve throughput to the throughput rate of change for such positions, for the prior art assembly shown in FIG. 1;

FIG. 3 is a plan view of a first embodiment of an improved flow control valve assembly in accordance with the present invention;

FIG. 4 is a plan view of a second embodiment of an improved flow control valve assembly in accordance with the present invention;

FIG. 5 is a plan view of a third embodiment of an improved flow control valve assembly having an accelerated valve member near the open position, in accordance with the present invention; and

FIG. 6 is a graphical representation of the relationship between angular positions of the drive motor and the ratios of valve throughput to the throughput rate of change for such positions, in accordance with the present invention.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENTS

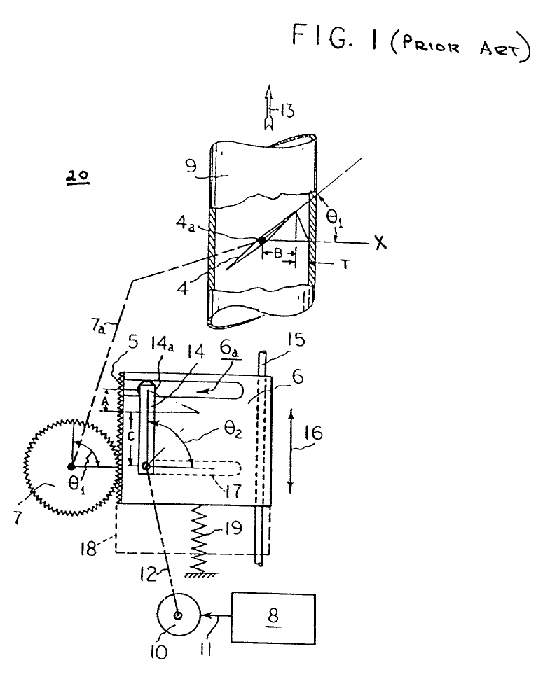

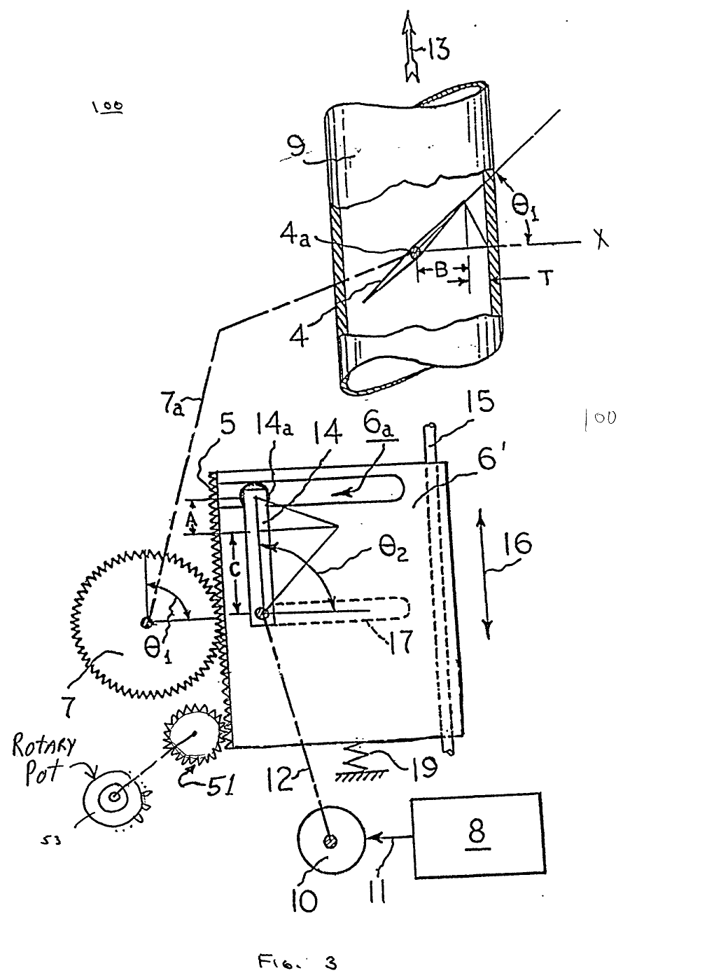

FIG. 3 shows an improved linearized flow control valve assembly 100 implementing a first preferred embodiment of an output signal generator in accordance with the present invention. Like the prior art linearized flow control valve assembly 20 of FIG. 1, the flow control valve assembly 100 of FIG. 3 includes a flow passageway 9 through which a fluid flows in the direction of arrow 13. A valve member 4 is disposed within the passageway such that the valve member is rotatable about a valve shaft axis 4a, which is transverse to the direction of fluid flow 13. The angular position of the valve member (i.e., valve member angle) is measured with respect to the closed position of the valve member, indicated by an orientation represented by the cross axis X. The cross axis X is preferably orthogonal to the shaft axis 4a and the direction of flow of fluid 13. The valve member angle is depicted by θ₁ and the throughput of the valve member is depicted by the projection T. The valve member is rotated in response to an input, preferably in the form of a rotatable motor shaft 12 of the motor 10. Unless compensation is provided, the relationship of the input (the angle of the motor shaft 12) and the output (the throughput T) is nonlinear throughout the range of valve member angles.

As with the valve assembly of FIG. 1, the valve assembly of FIG. 3 includes a compensatory cosine generator mechanism operatively disposed between an input source, preferably in the form of a motor shaft 12 of motor 10, and the valve shaft 4a. An electrical controller 8, which may be responsive to a sensed condition, such as pressure, flow or temperature, associated with the flow through the valved passageway 9, applies corresponding electrical control signals to motor 10 via a coupler 11 and, in the usual case, the motor output shaft 12 connects to the valve member 4 via a linearizing mechanism to effect related changes in the valve member angle θ₁ and the fluid flow. To compensate for the inherent pre-compensated non-linearity of the valve assembly 100, the linearizing mechanism includes a slide rack 6′ in combination with a pinion gear 7, wherein the linear movement of the rack 6′ causes rotation of pinion gear 7. Cam arm 14 is connected at one end to the motor shaft 12 and includes a roller 14a at its opposite end which is displaced within a cam slot 6a in rack 6′, so that rotation of cam arm 14 causes displacement of the roller 14a and a corresponding linear displacement of the rack 6′. The rack 6′ includes a linear series of rack teeth which engage a pinion gear 7 that is linked to valve member 4. Linear displacement of rack 6′ causes a corresponding rotational movement of pinion gear 7, which in turn effects the opening and closing of valve member 4. Spring 19 is used to remove any mechanical hysteresis or dead band in the cosine generator mechanism and motor 10. The rack 6′, cam components, and pinion gear 7 comprise the substantive portion of the compensatory mechanism for achieving a substantially linear relationship between the valve member angle of valve member 4 and the throughput T of the valve assembly.

In accordance with at least one aspect of the present invention, a first preferred embodiment of a linearized flow control valve assembly 100 of FIG. 3 includes a signal generator for generating an output signal representative of a angular position of the valve member 4. In one embodiment the signal generator is provided as a form of a linear position encoder which detects the linear displacement of rack 6′ and generates an output signal representative of a corresponding angular position of valve member 4. In this embodiment rack 6′ is extended to provide a sufficient segment of rack teeth to allow engagement with a circular gear 51, as well as with pinion gear 7. While rack 6′ is shown with one elongated series of rack teeth to accommodate both of pinion gear 7 and gear 51, the rack could be adapted with two distinct linear series of rack teeth, one for each of pinion gear 7 and gear 51, and in such a case the rack need not be extended. Additionally, while this and other embodiments of the rack are shown having gear teeth, other types of linear engagement mechanisms may be used, such as a smooth rack with pinion gear and gear rollers, or belts, or pulleys.

When rack 6′ experiences a linear displacement along shaft 15 in the direction of arrow 16 it causes a corresponding rotation of gear 51. In turn, gear 51 drives a rotary potentiometer 53 which generates an output signal indicative of its displacement and corresponding to the displacement of valve member 4. In another embodiment, gear 51 could also directly, or indirectly through intermediate gearing, engage the pinion gear 7, rather than by block 6′. In additional alternative embodiments, gear 51 may be omitted and a rotary potentiometer 53 may be directly engaged by either of pinion gear 7 or rack 6′. As those skilled in the art will appreciate, varying the ratio of the teeth of gear 51 and pinion gear 7 or the diameters or shapes of gear 51 and pinion gear 7 will result in corresponding changes in the output signal per incremental unit of valve member motion. Additionally, while gear 51 and pinion gear 7 are shown as having gear teeth, other types of engagement mechanisms could be used to achieve the translation of linear motion to rotational motion, such as rollers and belt mechanisms, as briefly alluded to above.

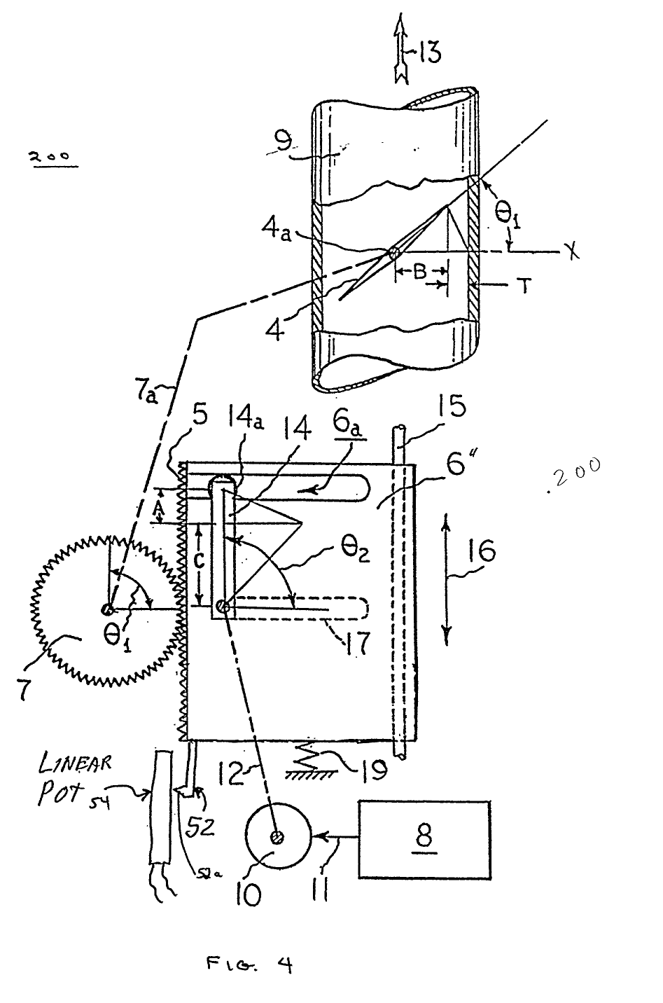

Referring to FIG. 4, a second embodiment of an improved linearized flow control valve assembly 200 and an alternative form of an output signal generator in accordance with the present invention is shown. In this embodiment, like that of FIG. 3, the rack 6″ is shown as elongated, though this is not critical in this embodiment. Rather than a rotary potentiometer, a linear encoder is used for detecting the linear displacement of the rack 6″, wherein such linear displacement relates to the angular position of the valve member 4. In this embodiment, arm 52 is fixed to rack 6″ and oriented in the direction of displacement of the rack. The arm includes a. pointer 52a which is oriented orthogonally to the orientation of arm 52. The pointer 52a moves relative to a linear potentiometer 54, with which it interacts to detect the linear translation of rack 6″ and generate signals representative of the corresponding positioning of valve member 4 with respect to cross axis X. Because arm 52 is fixed relative to rack 6″ and displacable in the same direction as the rack 6″, the displacement of pointer 52a is indicative of the displacement of the rack.

Those skilled in the art will recognize that other forms of encoders and output signal generators may be implemented to achieve embodiments of the present invention. For example, a combination of optical sources and detectors could be used to detect the linear displacement of the block. As an example, in such a system an optical source could be affixed to the rack and a series of optical detectors placed in a fixed position relative to the sliding rack for detecting movement of the rack. In such a case, the detectors would detect linear displacement of the optical source and, therefore, the rack, which is representative of the displacement of the valve member. Further, a rotary shaft angle encoder can be coupled directly to the shaft 4a of the valve member 4.

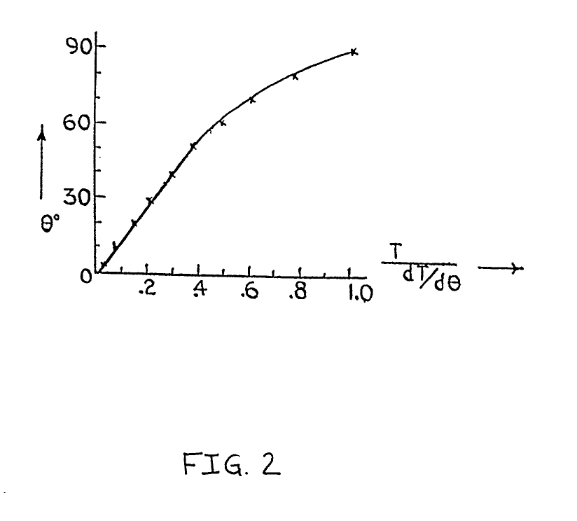

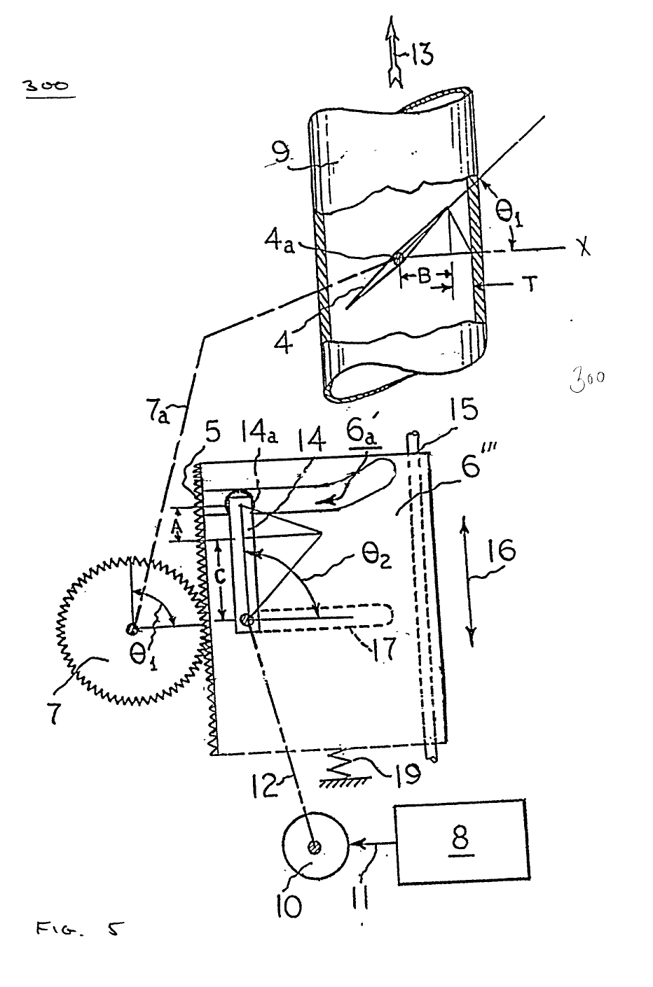

FIG. 5 shows a third embodiment of an improved linearized flow control valve assembly 300 in accordance with another aspect of the present invention. The valve assembly 300 includes an improved linearizing mechanism to provide a substantially consistent linear transfer function over valve member angles between the closed position at 0 degrees and the entirely open position at 90 degrees. As a result, the transfer function of the positioning the valve member 4 is substantially linearized in the non-linear range shown in FIG. 2. With the linearization of this non-linear region of response, the speed of the valve member 4 with respect to the rotation of motor shaft 12 is increased by changing the shape of the cam slot 6a′ in rack 6′″. In the prior art, the cam slot 6a is straight, but as shown in FIG. 5, in the preferred embodiment only a first portion of the cam slot 6a′ is straight. This first portion relates to the range of valve member angles from 0 to about 50 degrees, which, as shown in FIG. 2, is the range of substantial linearity for this type of linearize flow control valve assemblies.

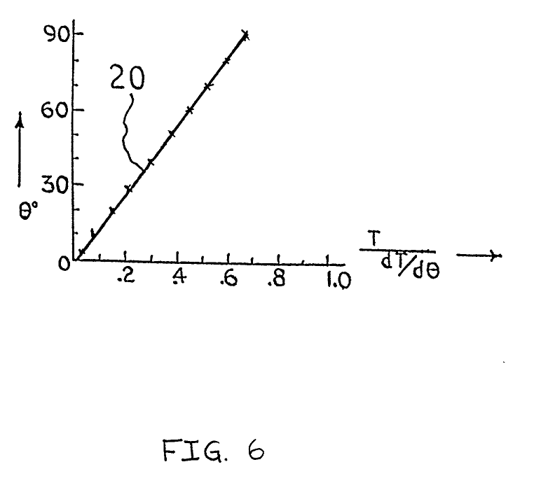

The closed position of the valve member corresponds to a valve member angle of θ₁=0° and the open position of the valve member corresponds to a valve member angle of θ₁=90°. In contrast to the prior art valve assembly 20 of FIG. 1, the second portion of cam slot 6a′, which relates to the near open position, is curved. The curve associated with valve member angles near the open position causes an acceleration of the motion of the valve member 4 in this region of valve member angles. The form of the curve of cam slot 6a′ is chosen as a function of the trail-off (or change in linearity) associated with valve member angles in the range of about 50 to 90 degrees, such that the curve compensates out this trail-off and results in a linearity graph essentially as shown in FIG. 6, having a substantially linearity over the entire range of 0-90 degrees. The curved cam slot 6a′ is preferably used with each embodiment described herein. In alternative embodiments, rather than curving the cam slot 6a, the pinion gear 7 or rack could be reshaped, for example, as a function of the change in linearity (or trail-off) to serve the same compensation and increased speed of the valve member near the open position.

It should be appreciated that a valve assembly can be constructed to include a valve member position sensor arranged and constructed so as to provide an output signal representative of the position of the valve member relative to the closed position, and an improved linearizing mechanism for linearizing the transfer function of the valve assembly throughout the entire range of valve member angles. In addition, while the input drive mechanism is shown as a motor, other drive mechanism can be employed including mechanical and electrical devices. The linearizing mechanism, while shown as the type disclosed in the '894 patent and improved according to the present invention, can also take other forms such as other mechanical and electrical configurations.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A fluid flow control valve assembly comprising:
a valve member disposed across a cross section of a passageway through which fluid flows and rotatable about a valve shaft axis which is transverse to the flow of fluid, the valve member being rotatable between an open and closed position and the throughput through the passageway being a nonlinear function of the position of the valve member relative to its closed position;
a motive source operatively connected to the valve member so that motive source provides a variable input representative of a desired throughput;
a linearizing mechanism coupled between the valve member and motive source so that equal incremental changes in the input of the motive source produces equal incremental changes in the throughput at least through a predetermined range of positions of the valve member; and
a valve member position sensor arranged and constructed so as to provide an output signal representative of the position of the valve member relative to the closed position.

2. A fluid flow control valve assembly of claim 1, wherein the valve member position sensor is in a sensing relationship to the linearizing mechanism, wherein the valve position sensor produces output signals representative of the angular position of said valve member with respect to the closed position.

3. The fluid flow control valve assembly of claim 1, wherein the linearizing mechanism includes a rack constructed and arranged so as to displace in a linear direction, the valve member position sensor includes an encoder in sensing relation to the linear displacement of the linear mechanism, and said encoder generates output signals representative of the angular position of said valve member with respect to the closed position in response to the linear displacement of said rack.

4. The fluid flow control valve assembly of claim 3, wherein the encoder is a potentiometer.

5. The fluid flow control valve assembly of claim 4, wherein the potentiometer is a rotary potentiometer.

6. The fluid flow control valve assembly of claim 4, wherein the potentiometer is a linear potentiometer.

7. The fluid flow control valve assembly of claim 4, wherein the rack is movable along a linear shaft and is in operative communication with a translator, wherein said translator is coupled to said motive source and causes a linear displacement of said rack in response to a rotational force applied by the motive source, and wherein the rack is linked to said valve member such that the linear displacement of said rack causes a corresponding rotational movement of said valve member about said valve shaft axis.

8. The fluid flow control valve assembly of claim 7, wherein the link between the rack and said valve member includes a pinion gear engaged with said rack and coupled to said valve member.

9. The fluid flow control valve assembly of claim 8, wherein the pinion gear is shaped to compensate for trail-off and changes in linearity of the relationship between the throughput of the valve assembly the angular position of the valve member.

10. The fluid flow control valve assembly of claim 8, wherein the rack includes a linear series of rack teeth disposed parallel to the direction of the linear displacement of the rack; and the pinion gear includes a series of gear teeth in operative communication with said rack teeth.

11. The fluid flow control valve assembly of claim 7, wherein the translator includes:
a cam arm having a first end rotatably secured to said rack and a second end having a roller rotatably secured thereto, wherein the motive source is in rotatable operative communication with said cam arm; and
a cam slot formed within said rack and oriented substantially transverse to the linear displacement of said rack, wherein the roller travels within said cam slot in response to a rotational force applied to said cam arm by said motive source.

12. The fluid flow control valve assembly of claim 11, wherein the cam slot is adapted to compensate for trail-off and changes in linearity of the relationship between incremental changes in the input of the motive source and incremental changes in the throughput outside the predetermined range of positions of the valve member.

13. The fluid flow control valve assembly of claim 12, wherein a portion of the cam slot is curved.

14. The fluid flow control valve assembly of claim 4, wherein the valve position sensor includes:
a potentiometer in sensing relation to the linear displacement of the rack, wherein said potentiometer produces output signals representative of the angular position of said valve member with respect to said closed position in response to the linear displacement of said rack.

15. The fluid flow control valve assembly of claim 14, wherein the encoder is a potentiometer.

16. The fluid flow control valve assembly of claim 4, wherein the rack includes a linear engagement portion oriented parallel to the direction of linear displacement of the rack and wherein the valve position sensor includes an encoder in sensing relation to said linear engagement portion.

17. The fluid flow control valve assembly of claim 16, wherein the encoder is an optical encoder.

18. The fluid flow control valve assembly of claim 16, wherein the encoder is a potentiometer.

19. The fluid flow control valve assembly of claim 16, wherein the linear engagement portion is a series of rack teeth; and the encoder is a rotary potentiometer having gear teeth and in operative communication with said rack teeth such that the linear displacement of said rack causes a corresponding rotation of said rotary potentiometer.

20. The fluid flow control valve assembly of claim 16, wherein the linear engagement portion is a series of rack teeth; and the valve position detector and signal generator includes a rack gear in operative communication with said rack teeth, and the encoder is a rotary potentiometer in operative communication with said rack gear.

21. The fluid flow control valve assembly of claim 16 wherein the encoder is a linear encoder.

22. The fluid flow control valve assembly of claim 21, wherein the valve position sensor includes an arm having a pointer affixed to the rack and disposed parallel to the direction of motion of the linear displacement of the rack and in operative communication with said linear encoder.

23. A fluid flow control valve assembly comprising:
a valve member disposed across a cross section of a passageway through which fluid flows and rotatable about a valve shaft axis, which is transverse to the flow of fluid, through a range of valve member angles between a fully closed position and a fully opened position, wherein the throughput of fluid through the passageway is a nonlinear function of the valve member angle relative to the closed position;
an input driving source having a movable input device that is movable through a predetermined range; and
a linearizing mechanism coupling the input driving source and valve member and constructed so as to provide a substantially linear transfer function between the position of the input element and the throughput of fluid through the passageway throughout the range of valve member angles.

24. A fluid flow control valve assembly according to claim 23, wherein the valve member angle of the valve member in the completely opened position relative to the closed position is at or about 90°.

25. A fluid flow control valve assembly according to claim 23, wherein the input driving source is a motor, the movable input device is the motor shaft of the motor rotatable through a predetermined range of angles in response to a control function input, and the linearizing mechanism provides a linear relationship between the angle of the motor shaft and the throughput through the passageway.

26. A fluid flow control valve assembly according to claim 23, wherein the linearizing mechanism includes:
a rack displacable along a linear shaft and including a linear series of rack teeth disposed parallel to the direction of linear displacement of said rack;
a cam arm having a first end rotatably secured to said rack and a second end having a roller rotatably secured thereto; and
a cam slot formed within said rack and orientated substantially transverse to the linear displacement of said rack, wherein the roller travels within said cam slot in response to rotation of said cam arm.

27. A fluid flow control valve assembly according to claim 26, wherein the cam slot includes a substantially linear portion and a curved nonlinear portion, wherein the roller travels in the substantially linear portion for valve member angles between 0° and about 50°, and travels in the curved nonlinear portion for valve member angles between about 50° to the valve member angle at the completely opened position.

28. A fluid flow control valve assembly according to claim 23, further including:
a pinion gear engaged with said rack teeth and coupled to said valve member;
a motor responsive to a controller and in rotatable operative communication with said valve cam arm via an output shaft; and
a valve position detector and signal generator, including an encoder in sensing relation to the linear displacement of said rack, wherein said encoder produces output signals representative of the angular position of said valve member with respect to said cross axis in response to said linear displacement of the rack.

29. A fluid flow control valve assembly comprising
a valve member disposed across a cross section of a passageway through which fluid flows and rotatable about a valve shaft axis which is transverse to the flow of fluid, wherein the throughput of fluid through the passageway is a function of the angle of the valve member relative to closed position;
a linearizing mechanism including:
a rack displacable along a linear shaft and including a linear series of rack teeth disposed parallel to the direction of linear displacement of said rack;
a cam arm having a first end rotatably secured to said rack and a second end having a roller rotatably secured thereto;
a cam slot formed within said rack and orientated substantially transverse to the linear displacement of said rack, wherein the roller travels within said cam slot in response to rotation of said cam arm;
a pinion gear engaged with said rack teeth and coupled to said valve member;
a motor responsive to a controller and in rotatable operative communication with said valve cam arm via an output shaft; and
a valve position detector and signal generator, including an encoder in sensing relation to the linear displacement of said rack, wherein said encoder produces output signals representative of the angular position of said valve member with respect to said cross axis in response to said linear displacement of the rack.

30. The fluid flow control valve assembly of claim 29, wherein the cam slot is curved to compensate out trail-off and changes in linearity of the relationship between the throughput of the valve assembly the input.

31. A fluid flow control valve assembly comprising:
a valve member disposed across a cross section of a passageway through which fluid flows and rotatably positionable about a valve shaft axis which is orthogonal to the flow of fluid, wherein the throughput of fluid through the passageway is a function of the angle of the valve member relative to a cross axis, wherein said cross axis is orthogonal to the direction of the flow of fluid and orthogonal to the valve shaft axis;
a linearizing mechanism including:
a rack displacable along a linear shaft and including a linear series of rack teeth disposed parallel to the direction of linear displacement of said rack;
a cam arm having a first end rotatably secured to said rack and a second end having a roller rotatably secured thereto;
a cam slot formed within said rack and orientated substantially transverse to the linear displacement of said rack, wherein the roller travels within said cam slot in response to rotation of said cam arm and wherein the cam slot is curved to compensate out non-linearity in the relationship of the throughput of valve assembly relative to the angular position of said valve member; and
a pinion gear engaged with said rack teeth and coupled to said valve member; and
a motor responsive to a controller and in rotatable operative communication with said valve cam arm via an output shaft.
